(19) United States
(12) Patent Application Publication
(10) Pub. No.: US 2009/0319791 A1
(43) Pub. Date: Dec. 24, 2009

(54) ELECTRONIC APPARATUS AND COPYRIGHT-PROTECTED CHIP

(75) Inventors: Toshihiro Aiyoshi, Ome-shi (JP); Akihiko Sato, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/469,477

(22) Filed: May 20, 2009

(30) Foreign Application Priority Data
Jun. 24, 2008 (JP) 2008-164948

(51) Int. Cl. H04L 9/32; G06F 12/14

(52) U.S. Cl. 713/169; 713/193; 713/171

(57) ABSTRACT

According to one embodiment, a copyright-protected chip includes a selector which connects a host controller to a circuit in the copyright-protected chip, a second register in which a encrypted content key, decryption key generation information, and shared classified information stored in a storage device are stored, and a communication circuit which communicates with the host controller and transmits the encrypted content key and the decryption key generation information stored in the register to the host controller when an access module accesses content obtained by decrypting the encrypted content stored in a hard disk.

### CROSS-REFERENCE TO RELATED APPLICATIONS

This application is based upon and claims the benefit of priority from Japanese Patent Application No. 2008-164948, filed Jun. 24, 2008, the entire contents of which are incorporated herein by reference.

### BACKGROUND

1. Field

One embodiment of the invention relates to an electronic apparatus which plays back content whose copyright is protected and a copyright-protected chip.

2. Description of the Related Art

CPRM is used to store copyright-protected content in a memory card (see, Toru Kambayashi, Kenji Shimoda, and Hiroyuki Sakamoto, “Content Protection for SD Memory card”, Toshiba Review, Vol. 58, No. 6, 2003). A conventional card controller compatible with security such as copyright protection could only save a key alone for content in a card or encrypt the content. Although content could be stored in a hard disk, it was impossible to encrypt or decrypt the content without the card.

The above problem required a unique encryption technique for data in a hard disk. For this reason, when content was copied/moved to a card, it was necessary to re-encrypt the content. This took much time. In addition, encryption processing was performed by software, and the encryption/decryption logic in the controller could not be used.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the system configuration of an electronic apparatus according to the first embodiment of the present invention;

FIG. 2 is a flowchart showing a processing sequence performed by the electronic apparatus shown in FIG. 1; and

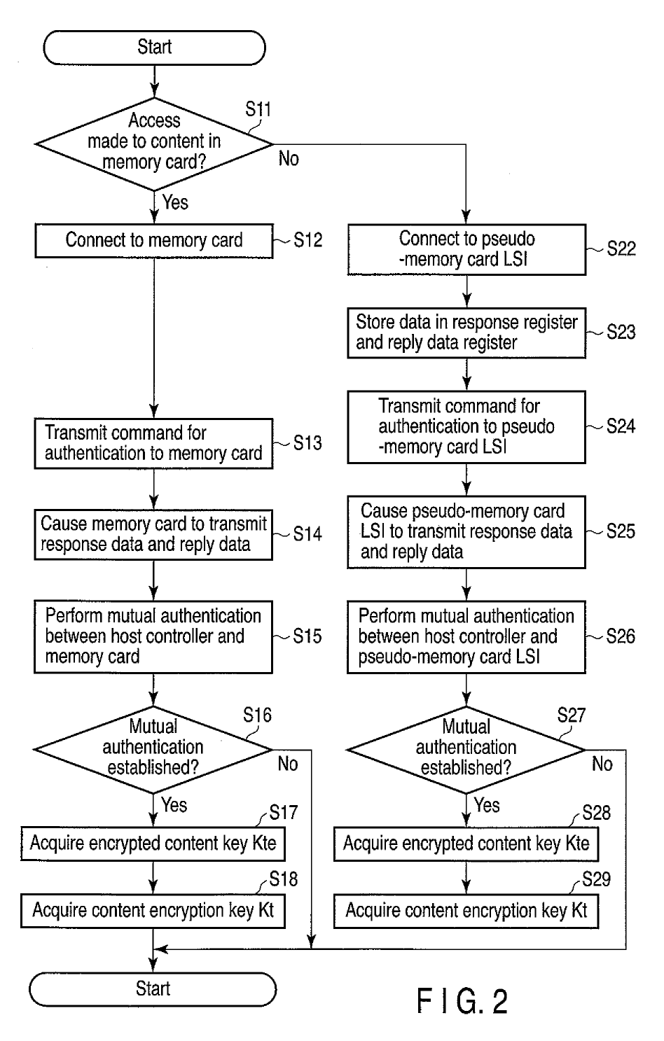

FIG. 3 is a block diagram showing the system configuration of an electronic apparatus according to the second embodiment of the present invention.

### DETAILED DESCRIPTION

Various embodiments according to the invention will be described hereinafter with reference to the accompanying drawings. In general, according to one embodiment of the invention, an electronic apparatus comprises a card slot configured to allow insertion/removal of a memory card in which encrypted content obtained by encrypting content by using a content key, an encrypted content key obtained by encrypting the content key, decryption key generation information for generation of a decryption key used to decrypt the encrypted content key, and shared classified information are stored, a storage device configured to store the encrypted content key, the decryption key generation information, and the shared classified information in a protected area, and to store a copy of the encrypted content in a data area, an access module configured to access content obtained by decrypting the encrypted content stored in the memory card inserted in the card slot or access content obtained by decrypting the encrypted content stored in the memory card inserted in the storage device, a host controller configured to acquire the decryption key generation information, to generate a decryption key from the decryption key generation information, to acquire the encrypted content key when mutual authentication using the shared classified information has succeeded, and to obtain the content key by decrypting the encrypted content key using the decryption key, a copyright protected chip including a selector configured to connect the host controller to the card slot when the access module accesses content obtained by decrypting the encrypted content stored in the memory card, and to connect the host controller to a circuit in the copyright protected chip when the access module accesses content obtained by decrypting the encrypted content stored in the hard disk, a first register configured to store response data to be transmitted to the host controller in response to a command transmitted from the host controller, a second register configured to store the encrypted content key, the decryption key generation information, and the shared classified information stored in the storage device, and a communication circuit, when the access module accesses content obtained by decrypting the encrypted content stored in the hard disk, communicates with the host controller, transmits decryption key generation information stored in the register, performs mutual authentication with the host controller, and transmits the encrypted content key to the host controller when the mutual authentication is established, and a storage module configured to store, in the second register of the copyright protected chip, the encrypted content key, the decryption key generation information, and the shared classified information stored in the storage device when the access module accesses content obtained by decrypting the encrypted content stored in the hard disk.

### First Embodiment

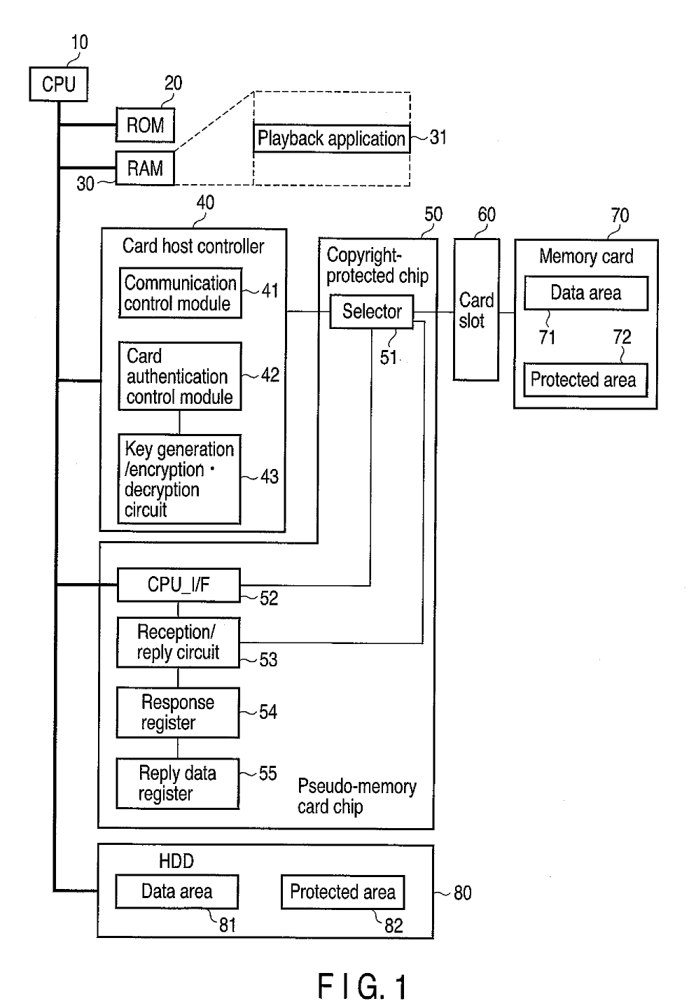

FIG. 1 is a block diagram showing the system configuration of an information processing apparatus according to the first embodiment of the present invention. As shown in FIG. 1, the information processing apparatus includes a central processing unit (CPU), a ROM 20, a RAM 30, a card host controller 40, a hard disk 80, a USB controller, a pseudo-card circuit, and the like.

A CPU 10 is a processor provided to control the operation of this apparatus, and executes a playback application 31 loaded from the ROM 20 into the RAM 30.

The card host controller 40 controls communication with a memory card 70 compatible with a copyright protection function which is inserted into a card slot 60. Encrypted content such as music data, image data, or video data which is compressed in advance is recorded in a data area 71 of the memory card 70. The following exemplifies a case in which the memory card 70 is an SD card equipped with a copyright protection function.

An encrypted content key Kte is stored in a protected area 72 of the memory card 70. The encrypted content key Kte is obtained by encrypting a content key Kt used for the encryption of content using a media key Km. The memory card 70 also has a media key block (MKB), a medial ID, and a media unique key Kmu obtained by encrypting the media ID using the content key Kt. A hard disk drive (HDD) 80 has a data area 81 and a protected area 82. Encrypted content stored in the memory card 70 can be copied or moved to the data area 81 of the HDD 80. Other files can be stored in the data area 81 of the HDD 80. The protected area 82 of the HDD 80 is an area which cannot be normally accessed and can be accessed by the playback application 31. The media ID, MKB, and the encrypted content key Kte which the memory card 70 has are stored in the protected area 82 of the HDD 80.

When the playback application 31 is to perform processing such as playback of encrypted content stored in the data area 81 of the HDD 80, a copyright-protected chip 50 communicates with the card host controller 40, and transmits the media ID, MKB, encrypted content key Kte, and media unique key Kmu stored in the protected area of the HDD 80.

The card host controller 40 performs MKB processing by using the media ID and MKB to generate a key for decrypting the encrypted content key Kte, and decrypts the encrypted content key Kte by using the generated key, thereby obtaining the content key Kt.

Note that the memory card 70 transmits the encrypted content key Kte to the card host controller 40 upon mutual authentication. Mutual authentication is performed by Authentication and Key Exchange (AKE).

AKE is a procedure by which a device sharing classified information authenticates a partner device by exchanging data with it in a manner which can be used by only devices having the classified information. In the memory card 70, this procedure is a challenge and response protocol dependent on a media key obtained as a result of MKB processing. As shared classified information on which AKE is based, the media unique key Kmu obtained by encrypting a media ID using a media key is used.

The card host controller 40 includes a communication control unit 41, a card authentication control unit 42 and, a key generation/encryption-decryption circuit 43.

The communication control unit 41 controls communication with the memory card 70. The card authentication control unit 42 performs mutual authentication by communication with the memory card 70 to be described later. The key generation/encryption-decryption circuit 43 performs generation of the media key Km by MKB processing, decryption processing of the encrypted content key Kte, encryption processing of content, and the like. The key generation/encryption-decryption circuit 43 generates the media key Km by MKB processing from an MKB and media ID.

The copyright-protected chip 50 includes a selector 51, a CPU interface 52, a reception/reply circuit 53, a response register 54, and a reply data register 55. The selector 51 is inserted midway along a communication line connecting the card slot 60 and the card host controller 40. When the playback application 31 or the like is to access content in the memory card 70 inserted in the card slot 60, the card host controller 40 is connected to the card slot 60 to allow the card host controller 40 to communicate with the memory card 70 inserted in the card slot 60. When the playback application 31 or the like is to access content in the HDD 80, the selector 51 connects the card host controller 40 to a circuit in the copyright-protected chip 50.

The CPU interface 52 is an interface for communication with the CPU 10. The bus which connects the CPU 10 to the copyright-protected chip 50 is a parallel bus. The bus in the copyright-protected chip 50 is a serial bus. For this reason, the CPU interface 52 performs parallel/serial conversion.

The reception/reply circuit 53 is a circuit which receives a command from the memory card 70, acquires a response to the command and parameters from the response register 54 and the reply data register 55, and returns the acquired response to the card host controller 40.

The response register 54 stores data required for communication with the card host controller 40, i.e., response data and the like required in terms of communication standards. A command stored in the response register 54 is like an ACK for acknowledging that a command has been received from the card host controller 40. The reply data register 55 also stores data required to decrypt content stored in the hard disk drive.

A case in which the card host controller 40 accesses encrypted content stored in the memory card 70 will be described first.

When accessing content in the memory card 70 (YES in block S11), the playback application 31 sets the selector 51 to connect the card host controller 40 to the card slot 60 (block S12).

The playback application 31 issues a command to the card host controller 40 to transmit a card command for authentication. The card host controller 40 outputs a card command corresponding to the issued command to a card interface upon adding parameters (block S13).

The memory card 70 then receives the card command for authentication which the card host controller 40 has transmitted via the card interface. The card analyzes the received card command, and returns response data indicating the validity of the command and reply data upon adding parameters (block S14). In this case, as the parameters, an MKB and a media ID are transmitted.

When the card host controller 40 receives the MKB and the media ID, the key generation/encryption-decryption circuit 43 generates the media key Km by performing MKB processing. The key generation/encryption-decryption circuit 43 generates the media unique key Kmu as shared classified information by using the generated media key Km. The card authentication control unit 42 performs AKE with the memory card 70 by using the media unique key (block S15). At the time of AKE, the encrypted content key Kte is exchanged.

If mutual authentication is established (YES in block S16), the card host controller 40 which has received the signal from the memory card 70 can obtain the encrypted content key Kte (block S17). The key generation/encryption-decryption circuit 43 can obtain the valid media key Km by decrypting the encrypted content key Kte using the media key Km (block S18). The controller 40 is then allowed to use an encryption logic. The card host controller 40 executes encryption or decryption processing of the content by using the encryption logic which is allowed to be used.

A case in which the playback application 31 plays back encrypted content stored in the hard disk drive will be described next. When accessing content in the HDD 80 (NO in block S11), the playback application 31 issues a command to the selector 51 to connect the card host controller 40 to a circuit in the copyright-protected chip 50. In accordance with this command, the selector 51 connects the card host controller 40 to the copyright-protected chip 50 (block S22).

The playback application 31 sets response data corresponding to a command for authentication, reply data response, and reply data in the register (block S23). Note that the playback application 31 reads out information necessary for the generation of the media key Km, e.g., an MKB and media ID, and data necessary for the decryption of the media unique key Kmu and the encrypted content key Kte from the protected area, and stores them in the reply data register 55.

The playback application 31 then transmits a command to the card host controller 40 to make it transmit a card command for authentication. The card host controller 40 transmits a command corresponding to the received command and parameters accompanying the command to the card interface (block S24).

The selector 51 transmits the transmitted signal to the reception/reply circuit 53. The reception/reply circuit 53 returns the data stored in advance in the response register 54 and the reply data register 55 (block S25). In this case, the MKB and media ID stored in the reply data register 55 are transmitted.

When the card host controller 40 receives the MKB and the media ID, the key generation/encryption-decryption circuit 43 generates the media key Km by performing MKB processing. The key generation/encryption-decryption circuit 43 generates the media unique key Kmu as shared classified information by using the generated media key Km. The card authentication control unit 42 then performs AKE with the copyright-protected chip 50 by using the media unique key (block S26). At the time of AKE, the encrypted content key Kte stored in the reply data register 55 is exchanged.

If mutual authentication is established (YES in block S27), the card host controller 40 which has received the signal from the reception/reply circuit 53 can obtain the encrypted content key Kte (block S28). The key generation/encryption-decryption circuit 43 can obtain the valid media key Km by decrypting the encrypted content key Kte by using the media key Km (block S29). The card host controller 40 is then allowed to use the encryption logic. The card host controller 40 executes encryption or decryption processing of the content stored in the HDD 80 by using the encryption logic which is allowed to be used.

In the above processing, authentication processing uses data stored in the protected area of the hard disk, and hence the generated encrypted content can be played back by using only this hard disk. This therefore implements copyright protection.

In addition, since generated encrypted content is generated by the same logic as that compatible with a card, when the encrypted content is to be copied or moved to the card, only key conversion can cope with this operation. This eliminates the necessity of a content re-encryption time.

### Second Embodiment

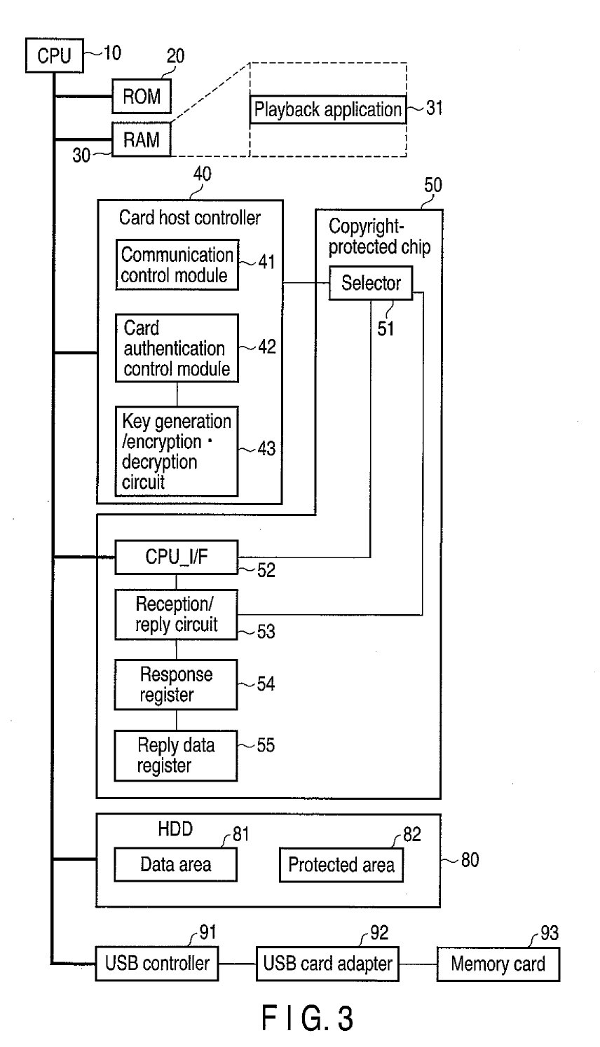

FIG. 3 is a block diagram showing the system configuration of an electronic apparatus according to the second embodiment of the present invention.

A case in which a USB card adapter 92 is connected to a USB controller 91, and copyright-protected content is generated in a memory card 93, as shown in FIG. 3, will be described. When the USB card adapter 92 is to be used, since data is received via the USB controller 91, the data is conventionally processed by only software.

(1) When a command for authentication processing is issued, transmission of the same command and parameters to the USB card adapter 92 by the USB driver is performed simultaneously with setting for registers 54 and 55 by a card host controller 40.

(2) The USB driver receives a response and reply data from the memory card 93, and sets the acquired response and reply data in the registers 54 and 55 of a copyright-protected chip 50 without performing conventional verification processing for received data using software. Note that a playback application 31 reads out information necessary for the generation of a media key Km, e.g., an MKB and media ID, and data necessary for the decryption of a media unique key Kmu and an encrypted content key Kte from the protected area, and stores them in the reply data register 55.

(3) The copyright-protected chip 50 sends back the data stored in the registers 54 and 55 to the card host controller 40. First of all, the copyright-protected chip 50 transmits the information necessary for the generation of the media key Km, e.g., the media ID. After generating the media key Km, the card host controller 40 performs mutual authentication using the media unique key Kmu.

(4) When mutual authentication is established, the card host controller 40 acquires the encrypted content key Kte. The card host controller 40 then acquires a content key Kt by decrypting the encrypted content key Kte using the media key Km.

(5) Upon acquiring the content key Kt, the card host controller 40 is allowed to use the encryption logic. The card host controller 40 executes encryption or decryption processing by using the encryption logic which is allowed to be used.

According to this embodiment, since processing all of which have been conventionally performed by software is partially performed by hardware (controller), the security level improves.

(Modification)

This apparatus can be integrated into one chip by embedding a card interface loopback circuit in a code controller chip.

In addition, this apparatus can be formed by only a hard disk arrangement without mounting any card slot.

Note that the memory card 70 can be of a type other than an SD memory card.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus comprising:
a card slot configured to couple with a removable memory card configured to store content encrypted with a content key, an encrypted version of the content key, decryption key generation information for generation of a decryption key for use in decrypting the encrypted version of the content key, and shared classified information;
a storage device configured to store the encrypted version of the content key, the decryption key generation information, and the shared classified information in a protected area, and to store a copy of the encrypted content in a data area;
an access module configured to access content after decrypting the encrypted content from either the removable memory card or the storage device;
a host controller configured to receive the decryption key generation information, to generate a decryption key from the decryption key generation information, to receive the encrypted version of the content key when mutual authentication using the shared classified information is successful, and to generate a decrypted content key by decrypting the encrypted version of the content key with the decryption key;
a copyright-protected chip comprising a selector configured to connect the host controller to the card slot when the access module accesses content after decrypting the encrypted content stored in the memory card, and to connect the host controller to a circuit in the copyright-protected chip when the access module accesses content after decrypting encrypted content stored in the storage device, a first register configured to store response data to the host controller in response to a command from the host controller, a second register configured to store the encrypted version of the content key, the decryption key generation information, and the shared classified information in the storage device, and a communication circuit configured to transmit decryption key generation information stored in the register to the host controller when the access module accesses content after decrypting the encrypted content stored in the storage device, to mutually authenticate with the host controller, and to transmit the encrypted version of the content key to the host controller when the mutual authentication is established; and
a storage module configured to store the encrypted version of the content key, the decryption key generation information, and the shared classified information in the second register of the copyright-protected chip when the access module accesses the decrypted content from the encrypted content in the storage device.

2. The apparatus of claim 1, wherein the mutual authentication comprises Authentication and Key Exchange (AKE).

3. The apparatus of claim 1, wherein the shared classified information comprises a media unique key which is a media ID in the memory card encrypted with the decryption key.

4. The apparatus of claim 1, wherein the memory card is an SD memory card compatible with a copyright protection function.

5. A copyright-protected chip in an electronic apparatus and between a card slot which is configured to couple a memory card and a host controller, the copyright-protected chip comprising:
the memory card comprises content encrypted with a content key, an encrypted version of the content key as a result of encrypting the content key, decryption key generation information for generation of a decryption key for use in decryption of the encrypted version of the content key, and shared classified information,
the host controller is configured to receive the decryption key generation information, to generate a decryption key from the decryption key generation information, to receive the encrypted version of the content key when mutual authentication using the shared classified information is successful, and to receive the content key by decrypting the encrypted version of the content key using the decryption key,
the electronic apparatus comprises a storage device configured to store the encrypted version of the content key and a copy of the decryption key generation information in a protected area and a copy of the encrypted content in a data area, and an access module configured access content after decrypting the encrypted content either in the memory card in the card slot or in the storage device, and
the copyright-protected chip comprises
a selector configured to connect the host controller to the card slot when the access module accesses the decrypted content from the memory card, and to connect the host controller to a circuit in the copyright-protected chip when the access module accesses the decrypted content from the storage device,
a first register configured to store response data to the host controller in response to a command from the host controller,
a second register configured to store the encrypted version of the content key, the decryption key generation information, and the shared classified information stored in the storage device, and
a communication circuit configured to transmit decryption key generation information stored in the register to the host controller when the access module accesses the decrypted content from the storage device, to mutually authenticate with the host controller, and to transmit the encrypted version of the content key to the host controller when the mutual authentication is established.

6. The chip of claim 5, wherein the mutual authentication comprises Authentication and Key Exchange (AKE).

7. The chip of claim 5, wherein the shared classified information comprises a media unique key which is a media ID in the memory card encrypted with the decryption key.

8. The chip of claim 5, wherein the memory card is an SD memory card compatible with a copyright protection function.

9. A content protection method wherein content encrypted with a content key, an encrypted version of the content key as a result of encrypting the content key, decryption key generation information for generation of a decryption key for use in decrypting the encrypted version of the content key, and shared classified information are in a memory card, the encrypted content is in a storage device, and content in the storage device is accessed, the method comprising:
connecting a host controller configured to control communication with the memory card to a copyright-protected chip in a signal line between the host controller and the memory card when an access is made to content as a result of decrypting the encrypted content in the memory card;
storing response data to be transmitted to the host controller in response to a command from the host controller into a first register in the copyright-protected chip;
storing an encrypted version of the content key and decryption key generation information in a protected area of the storage device into a second register in the copyright-protected chip;
causing the copyright-protected chip to transmit the decryption key generation information in the register to the host controller;
causing the controller to generate the decryption key from the decryption key generation information;
causing the host controller to receive the encrypted version of the content key in the register of the copyright-protected chip when the copyright-protected chip and the host controller has mutually authenticated by using the shared classified information; and
causing the host controller to receive the content key by decrypting the encrypted version of the content key using the decryption key.

10. The method of claim 9, wherein the mutual authentication comprises Authentication and Key Exchange (AKE).

11. The method of claim 9, wherein the shared classified information comprises a media unique key which is a media ID in the memory card encrypted with the decryption key.

12. The method of claim 9, wherein the memory card is an SD memory card compatible with a copyright protection function.
